(19) United States
(12) Patent Application Publication
(10) Pub. No.: US 2008/0319798 A1
(43) Pub. Date: Dec. 25, 2008

(54) PERSONALIZED MEDICAL INFORMATION CARD AND METHOD FOR MANAGING SAME

(76) Inventor: James M. Kelley, Scottsdale, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/143,463

(22) Filed: Jun. 20, 2008

Related U.S. Application Data
(60) Provisional application No. 60/945,261, filed on Jun. 20, 2007.

(51) Int. Cl. G06Q 50/00; G06Q 10/00

(52) U.S. Cl. 705/3

(57) ABSTRACT

A method for managing an individual's personal medical information includes creating an online medical information record which contains the individual's stored personal medical information, providing the individual with a physical credit card sized card which includes the individual's key medical information from the individual's online medical information record that would be most needed in times of medical emergency and directions for accessing the individual's online medical information record, enabling the individual to update his or her online medical information record with the individual's most recent medical information; and enabling the individual and others to view a read only version of the individual's online medical information record.

### CROSS-REFERENCE TO RELATED APPLICATIONS

This application claims priority to provisional patent application having Ser. No. 60/945,261, filed Jun. 20, 2007, which is herein incorporated in its entirety.

### FIELD OF INVENTION

The present invention relates, generally, to a method for managing an individual's personal medical information, with an emphasis on preparedness for a medical emergency and utilizing a method for managing an individual's personal medical information which includes a physical credit card sized medical information card and a medical information database that can be updated via the internet. The physical credit card sized medical information card includes directions to access the medical information database so that health care providers can view additional medical information and images for an individual they are treating.

### BACKGROUND OF THE INVENTION

Today's medical environment is a patchwork of providers and episodes of care in a variety of settings. A typical patient usually has a primary care physician they don't know very well and an assortment of consulting specialists. Patients may receive care in a variety of settings which include a doctor's office, specialty clinics, emergency departments, and/or urgent care facilities.

In addition, a number of individuals spend a significant amount of time yearly on business travel and/or traveling seasonally outside of their home state. A lack of cohesion in care and a fragmented medical record can often result when individuals must seek medical care when away from home. Patients often surrender some measure of control in organizing and protecting their medical information when receiving such fragmented care.

Ultimately, as patients receive healthcare in varied settings and by assorted unrelated physicians, the potential exists for errors and inefficiencies in care caused by this pattern of healthcare delivery. This potential is amplified in the emergency care setting where the urgency of the situation requires accurate and timely medical information. A lack of such information in this setting has the potential to adversely affect the outcome of ones' care.

Since the majority of people carry no medical or emergency contact information on their person, many decisions made by medical care providers in an emergency are made with incomplete information about a patient. Healthcare consumers today have shown an increasing desire to have some measure of control and decision making ability in receiving medical care. Accordingly, there has been increased interest in a method for managing personalized medical information which enables an individual to store and access all or a select portion of one's medical information with the ability to provide ongoing updates and correction to this information. There is also a need for a method to manage personalized medical information which enables immediate access to an individual's most current medical information by the individual, medical providers treating the individuals, and family members of the individual. Since emergency care situations require more urgent accessibility to an individual's medical information, these situations represent the greatest potential to improve healthcare outcomes through better information access.

### SUMMARY OF THE INVENTION

The present invention is directed to an information framework designed around emergency care situations which enables individuals to maintain and update their unique medical information profiles in preparation for an unanticipated medical emergency. The structure of the database for this framework is organized around key medical information facts that would be most valued by treating medical providers. The present invention provides a secure place for individuals and families to store key individual medical facts and documents which can be readily accessed in time of need, and in particular in times of emergency.

The method for managing an individual's personal medical information of the present invention provides access to an internet site which contains an informational template by which patients or families can input key pieces of individual medical information. In addition, advanced medical information such as a current EKG, specialty test results, and/or important medical legal documents can be stored and made accessible when needed. Individuals are guided through established online templates to input various medical facts which can then be edited at any time by the individual. The individual is assisted in inputting various medical facts to create a virtual medical information card by being presented with an array of definitions and examples. This virtual information card is reviewed and approved to be accurate by the individual and then printed in a hard tangible and directly readable credit card form. Additional medical information and images including and beyond that on the virtual information card will also be stored on the internet site. Some medical information and legal information will be able to be stored in its original format and then accessed by the individual and others when the need arises. Several methods may be used to input these original documents such as scanning or faxing these documents to a virtual file that can be distributed to appropriate informational categories within the medical record.

When needed, the individual's medical information will be made available in a password protected environment to treating medical providers via several possible methods. Providers may access information directly through a computer via the internet, or a PDA, cell phone, or other web-enabled device. In addition, the individual will have the ability to fax or e-mail their personal medical information or selected portions of their personal medical information to a provider or hospital fax or computer using the individual's computer via the internet, or the individual's PDA, cell phone, or other web-enabled device. Further, the individual may also obtain a physical record of their medical information by printing all of their medical information or selected parts of their medical information in a standard size paper form or a reduced size credit card form. For example, some individuals may wish to frequently reprint their medication list as changes are made in their medications so that they can carry the most updated list of their medications in some physical form. Once individuals initially access the method for managing personal medical information of the present invention, they will also be provided with a physical credit card sized card which contains key medical facts and information that is most necessary during a time of emergency and, if appropriate, a picture and/or reduced size EKG image. The information contained on the physical credit card sized card will include only the key medical information for the individual that is most needed for medical emergencies. The website associated with the virtual medical information database is where the individual and others can access additional read only medical information and images relating to the individual. The individual can also use this website to update his or her medical information so that the virtual medical information database contains the individual's most recent medical information.

The method for managing an individual's personal medical information of the present invention includes the steps of 1) providing internet access to a program for entering and storing an individual's personal medical information, 2) creating an online record which contains the individual's stored personal medical information, 3) providing the individual with a physical credit card sized card which includes the individual's key medical information that would be most needed in times of medical emergencies, and 4) enabling the individual and others to view read only versions of the individual's complete online medical information record. The method also includes the step of enabling the individual to update his or her online medical information record. In addition, the method may also include the step of enabling the individual and/or others to print the individual's most current online medical information record or portions of that record. Further, in the event that an individual's key medical information changes, the method also includes the step of enabling the individual to print a standard size or credit card sized version of the most current key medical information needed in times of emergency thereby producing an up-to-date physical medical information card that can be carried by the individual.

The present invention is also directed to a physical medical information card which includes key medical information for an individual that is most needed in medical emergencies and directions for accessing a website which contains recent additional medical information and/or medical images relating to the individual. The website may also contain important video images and/or audio recordings relating to the individual which have been downloaded by the individual.

An additional unique feature of the physical medical information card includes a means of demonstrating affiliation with or connection to various business and charitable organization through the use of a defined space within the physical medical information card which will prominently display graphic or textual information related to the business or charitable entity including logos, symbols, text, images, etc.

### BRIEF DESCRIPTION OF THE DRAWINGS

A more complete understanding of the present invention may be derived by referring to the detailed description and claims when considered in connection with the following illustrative figures. In the following figures, like reference numbers refer to similar elements throughout the figures.

FIG. 1 is a schematic showing the components of an exemplary embodiment of the personal medical information card system of the present invention.

FIG. 2 is a flowchart showing an exemplary embodiment of a method for managing an individual's personal medical information in accordance with the present invention.

FIG. 3 is an exemplary computer screen showing an online template in accordance with the present invention for inputting an individual's medical information.

FIG. 4 is another exemplary computer screen showing an individual's online medical information record and a mock up of the individual's physical medical information card which can be printed in credit card size format.

FIG. 5A shows an exemplary presentation of a front side of an individual's physical medical information card in accordance with the present invention.

FIG. 5B shows an exemplary presentation of a back side of an individual's physical medical information card in accordance with the present invention.

FIG. 6 shows an exemplary presentation of a front side of an individual's physical medical information card which includes the logo of an affiliate or sponsor of the medical information card of the present invention.

FIG. 7 is a flowchart showing an exemplary method for managing text messages, documents, and/or video images in association with the method for managing an individual's personal medical information card in accordance with the present invention.

### DETAILED DESCRIPTION

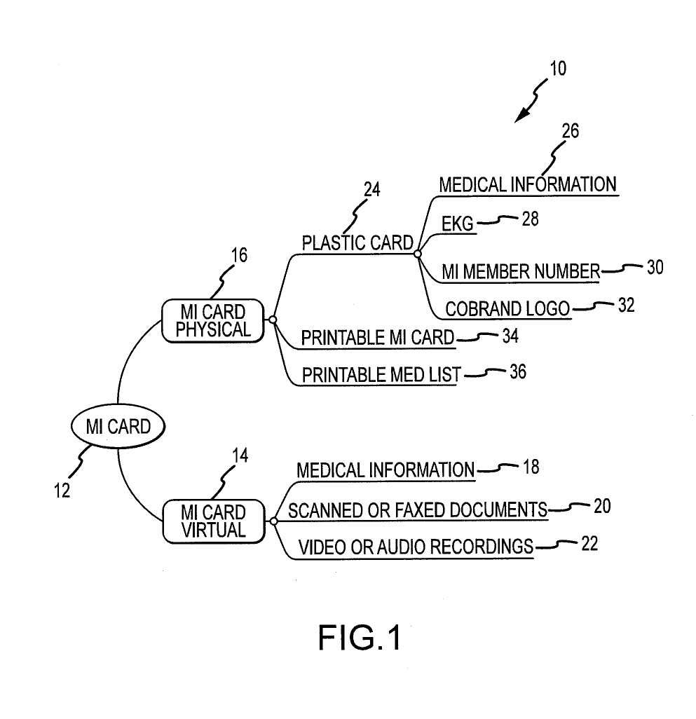

The present invention is directed to a method for managing an individual's personal medical information which includes an online (or virtual) medical information record and a physical credit card size medical information card which contains the individual's key medical information most needed in times of emergency along with directions for accessing the individual's more complete online medical information record. Turning now to the figures, FIG. 1 is a schematic showing the components of an exemplary embodiment of the personal medical information card system 10 of the present invention. Personal medical information card system 10 includes a program 12 for entering and storing an individual's personal medical information where the program 12 is accessible over the internet. Program 12 generates an online (virtual) medical information record 14 and a physical credit card size medical information card 16 which can be carried by the individual. Online medical information record 14 may include any number of items including, but not limited to, medical information 18 that is entered by the individual, scanned or faxed documents 20 which may be inputted by the individual, and video or audio recordings 22 which may be inputted by the individual. Physical credit card size medical information card 16 may include a card made of plastic 24 which includes key medical information 26 needed in times of emergency, key medical images such as, for example, an EKG image 28, an individual's medical information card member number 30, and a branding entity name and/or logo 32. The personal medical card information system 10 also includes a mock up of an individual's physical credit card size medical information card 16 which contains the individual's most recently updated medical information that has been inputted to the individual's online medical information record 14. This mock up of the individual's most recently updated physical credit card size medical information card can be printed in the form of a transportable paper card 34. An updated medications list 36 may also be printed from the individual's most recently updated medical information record 14.

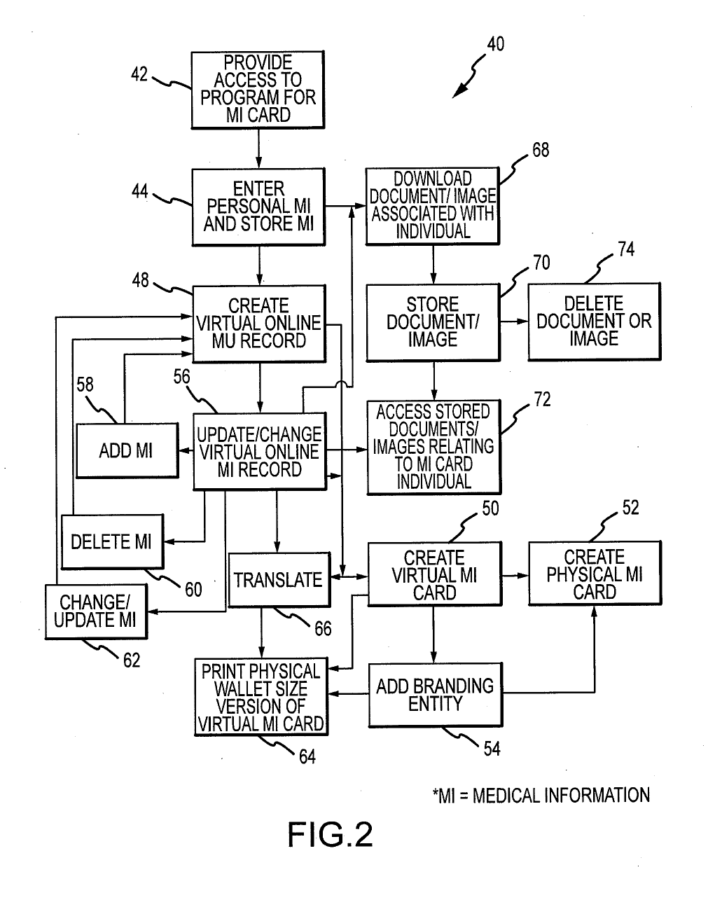

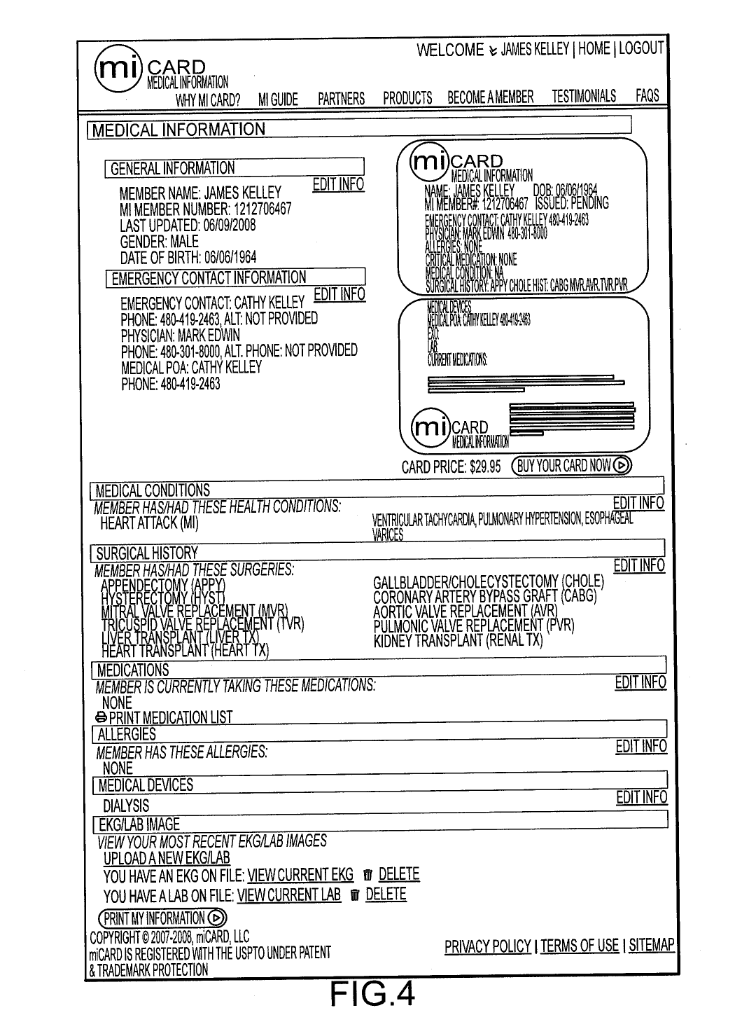

FIG. 2 is a flowchart 40 showing an exemplary embodiment of a method for managing an individual's personal medical information in accordance with the present invention. An individual is first provided with access to a program for entering and storing their personal medical information in step 42. Access to this program is provided over the internet and therefore it is also accessible via any handheld device such as PDAs, cell phones, etc. that have internet capabilities. In step 44, the individual enters or inputs their person medical information using template screens that guide them through this process and the information is stored in a database. The template screens prompt the individual to input the necessary information by asking questions and providing answer options and/or exemplary answers. A personal online medical information record is created for the individual in step 48 and the personal online medical information record is based on the medical information that was entered and stored in step 44. An example of an individual's personal online medical information record is shown in FIG. 4.

Once an individual's personal online medical information record is created, a virtual medical information card is created in step 50 which includes the individual's key medical information from the individual's personal online medical information record that would be most needed in times of medical emergency and directions for accessing the individual's personal online medical record. A physical medical information card is then created in step 52 which is an exact physical replica of the individual's virtual medical information card created in step 50. The individual's physical medical information card is preferably made of plastic and is preferably a credit card size card which is then sent to the individual so that the individual can keep their personal medical information card in their pocket, wallet, pocketbook, etc. This physical medical information card alerts emergency health care providers as to the individual's personal medical information most needed in times of emergency to treat the individual. It also provides health care providers with instructions for gaining a more complete online medical record relating to the individual.

An additional unique feature of the physical medical information card includes a means of demonstrating affiliation with or connection to a various business or charitable organization (i.e. a branding entity) through the use of a defined space within the physical medical information card which will prominently display graphic or textual information related to the business or charitable entity including logos, symbols, text, images, etc. Such a branding entity is added to the virtual medical information card in step 54 before it is created in the form of a physical medical information card in step 52. It may be that the physical medical information card created in step 52 is only created and sent to an individual once upon initially accessing the medical card information program in step 42, initially entering the individual's personal medical information in step 44. Later, updated versions of the individual's physical medical information card may be printed in step 64.

In step 56, an individual can update or change their personal online medical information record by adding medical information to their personal online medical information record in step 58, deleting medical information from their personal online medical information record in step 60, and/or changing existing medical information on their personal online medical information record to include more details regarding a medical condition, medication, etc, in step 62. Once the individual's online medical information record is updated in step 56, a virtual medical information card is created in step 50 which includes the individual's most updated key medical information from the individual's personal online medical information record that would be most needed in times of medical emergency and directions for accessing the individual's updated personal online medical record. This updated virtual medical information card created in step 50 can them be printed into a physical form of the card in step 64. The printed physical form of the updated virtual medical information card is preferably printed in a credit card or wallet size format but may also be printed in a larger sized format. This printed physical form of the updated virtual medical information card may also include a branding entity as previously described with reference to step 54. In addition, both the individual's online medical information record and the individual's virtual medical information card, which is based on the individuals' online medical information record, may be translated into another language in step 66. This enables a traveling individual to provide emergency health care providers with the necessary information needed in order to treat the individual in a time of emergency no matter where the individual is located.

The present invention's method for managing an individual's personal medical information may also enable an individual to include additional information such as documents or images to his or her online medical information record. Once the individual enters and stores their personal medical information in step 44, the individual may download personal documents and/or images in step 68 which are them stored in a database in step 70. Once the virtual online medical information record is created in step 48 or updated in step 56, the individual or another having access to their personal online medical information record may access any personal documents or images in step 72 which have been previously stored in step 70. An individual may also update their stored documents and/or images by deleting certain documents and/or images in step 74 and downloading new documents and/or images in step 68 when updating the individual's virtual online medical information record. Documents and/or images referred to in steps 68, 70, 72 and 74 also include any video and or audio recordings which can be downloaded, stored, and accessed through the internet. Some examples of documents and/or images that an individual may elect to download and store in association with their personal online medical information record include, but are not limited to, electrocardiogram (EKG) print outs, medication lists, lab results, living wills, and audio and/or video instructions or messages to family members or health care providers.

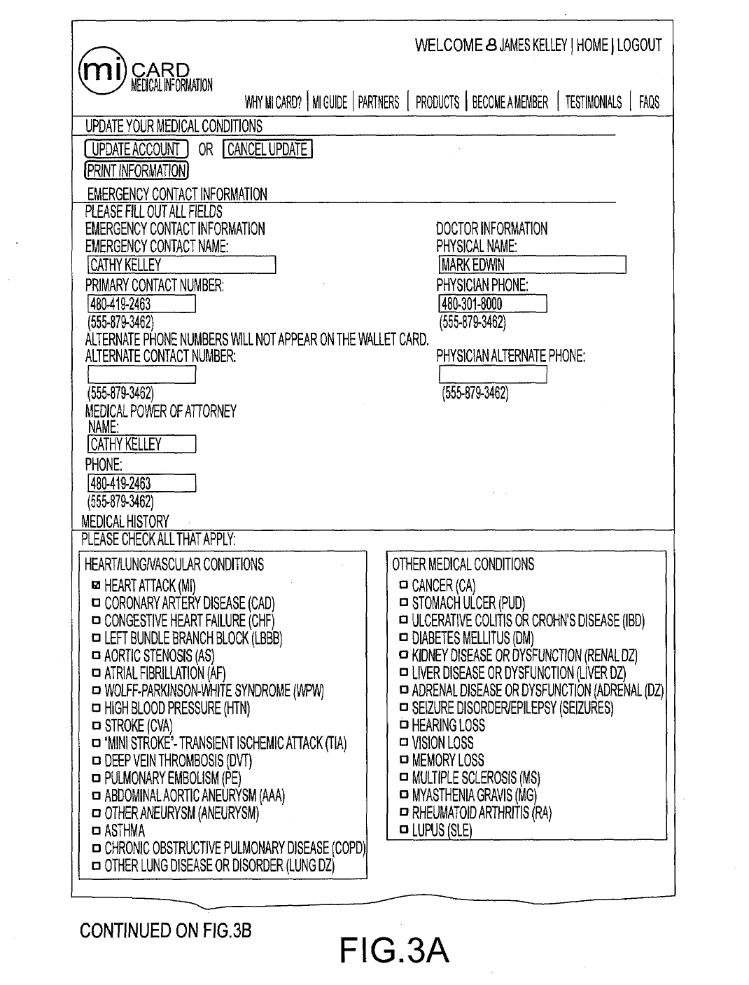

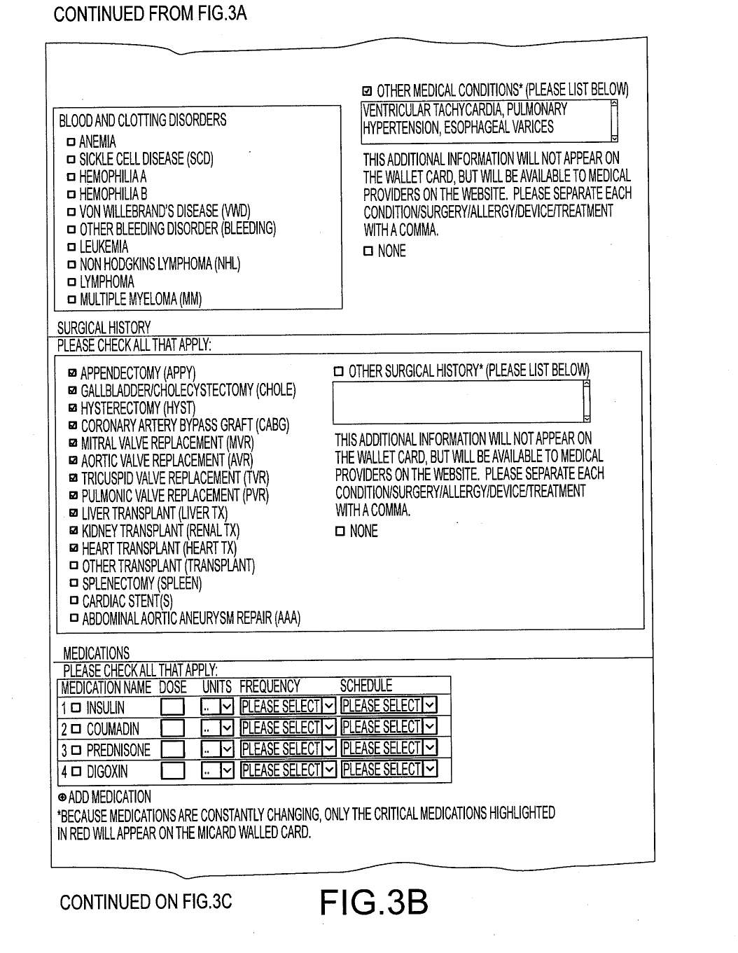

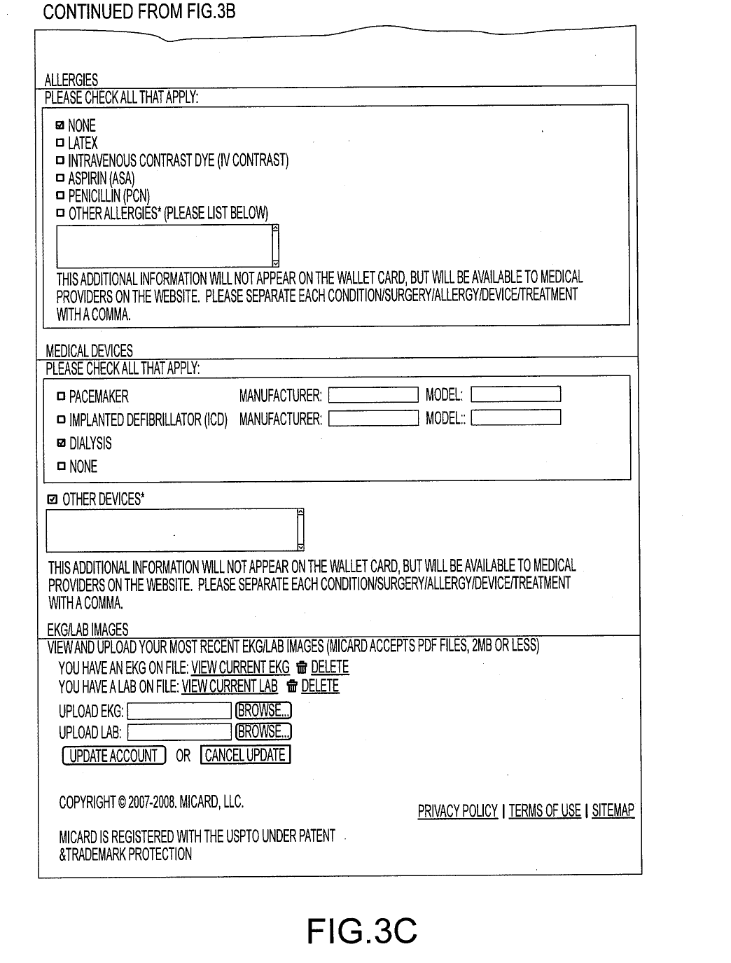

An exemplary computer screen showing an online template for inputting an individual's medical information in accordance with the present invention is shown in FIG. 3. Upon access to the medical information card program and registration with the service in step 42 of FIG. 2, individuals are presented with a medical information questionnaire in order to input and store their personal medical information in accordance with step 44 in FIG. 2. The screen shown in FIG. 3 is just one template of several that may be used as part of the medical information questionnaire to gather an individual's pertinent medical information in order to create a comprehensive personal online medical information record and related personal medical information card that can be used in times of medical emergency. The screen shown in FIG. 3 may also be used to update an individuals' medical information. The medical information questionnaire surveys for the presence of certain important medical conditions which would impact an individual's emergency medical care. This information is later provided in the form of a physical medical information card which is preferably the size of a credit card that can be easily stored in a pocket, a wallet, a pocketbook, etc. using common medical abbreviations, where possible, to conserve space. Since the credit card sized medical information card functions as an emergency medical record and space on the card is limited, the questionnaire prioritizes certain medical conditions and information. Additional information not found on the questionnaire may still be entered by an individual and later made available to treating health care providers on the website associated with the medical information card. The medical information questionnaire may include at least the following categories:

1) Individual's Name

2) Medical information card member number (The medical information card member number is automatically generated during the registration process and will allow treating medical care providers to view additional information about the individual on the website associated with the medical information card.)

3) Individual's date of birth

4) Date on which the individual's physical credit card sized medical information card was created (This enables treating medical providers to know the relative age of the information displayed on the individual's physical medical information card.)

5) An emergency contact (Someone that the individual would like to have notified first as to the individual's medical condition or someone who might best provide additional medical information about the individual.)

6) Physician's name (The name of the medical provider most knowledgeable about the individual's medical condition(s).)

7) Allergies (A list of medications or substances that causes the individual to have one or more of a rash, hives, itching, swelling, or shortness of breath. The medical information questionnaire will prioritize specific medications or substances that are commonly encountered during the early stages of emergency care so that health care providers can prevent the individual from being exposed to these medications or substances during emergency treatment.)

8) Critical medications (A list of specific medications that may affect decisions made by an emergency care provider—typically they are chronic medications that carry significant clinical importance. All other medications will be listed on the individual's personal online medical information record and will be able to be printed out by accessing the website associated with the medical information card. This list can be continually updated and organized by the individual.)

9) Medical conditions (A list of specific medical conditions that can affect treatment decisions made by medical care providers. Additional medical conditions can be entered and listed on the individual's online medical information record which can be viewed by a treating care provider by accessing the website associated with the medical information card.)

10) Surgical history (A list of surgical procedures which may affect decisions made by a treating care provider. Additional surgical procedures can be entered and listed on the individual's online medical information record which can be viewed by a treating care provider by accessing the website associated with the medical information card.)

11) Medical devices (A list of specific device or treatments which may affect decisions made by the individual's treating care provider. This information can help a treating provider assess the functional status of an implanted medical device. The manufacturer and model number of any implanted medical device can be entered and listed on the individual's online medical information record which can be viewed by a treating care provider by accessing the website associated with the medical information card.)

12) Medical power of attorney (also known as a “health care power of attorney” or “health care proxy”) (The name of an individual that has been granted legal authority to make medical decisions for the individual in the event that the individual is incapacitated due to illness.)

13) Electrocardiogram (also known as “EKG”) (A copy of an individual's EKG can be obtained from their physician or clinic and then uploaded into an EKG folder on the website associated with the medical information card so that the individual's EKG image can be included on the individual's online medical information record and/or the individual's physical medical information card.)

14) Lab results (A recent set of laboratory results can be obtained and then uploaded into an Lab folder on the website associated with the medical information card so that the individual's lab results can be included on the individual's online medical information record and/or the individual's physical medical information card. The lab results may include, but are not limited to, a complete blood count (CBC), a chemistry panel which includes electrolytes (Na, K, Cl, HCO₃), kidney tests (BUN, Cr), glucose, and liver tests (TB, AST, ALT, AP).)

15) Current medications (the website associated with the individual's personal online medical information record and physical medical information card provides a place for the individual to list, store, and print a current medication list. Dosages and frequencies for medications may also be listed. A print out of an updated medications list can be carried along with the individual's physical medical information card to provide care givers with an accurate and up-to-date list of current medications.)

If an individual's medical information exceeds the capacity of the credit card size physical medical information card, the card will direct health care providers to seek additional information about the individual on the website associated with the medical information card.

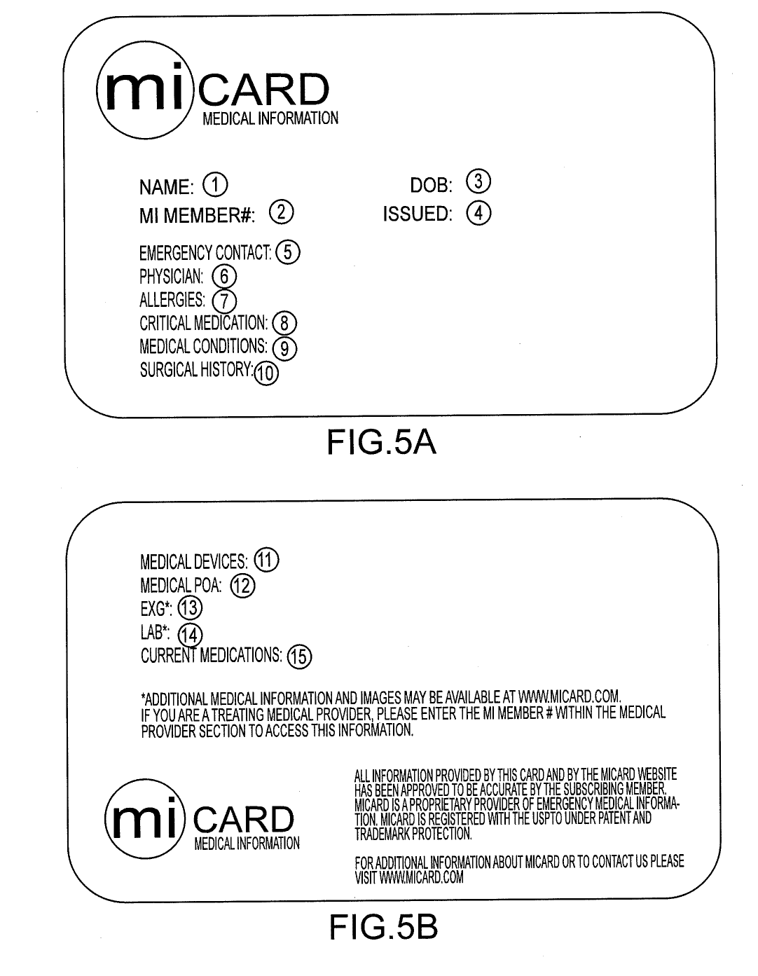

FIG. 4 is another exemplary computer screen showing an individual's online medical information record along with a mock up of the individual's physical medical information card (i.e. a virtual medical information card) that can be printed in credit card size format. FIGS. 5A and 5B show exemplary presentations of the front and back sides, respectively, of an individual's physical medical information card in accordance with the present invention. The front and back of the card include the individual's key medical information from the individual's online medical information record that is most necessary in times of medical emergency for treatment by health care providers along with instructions for accessing additional online medical information relating to the individual.

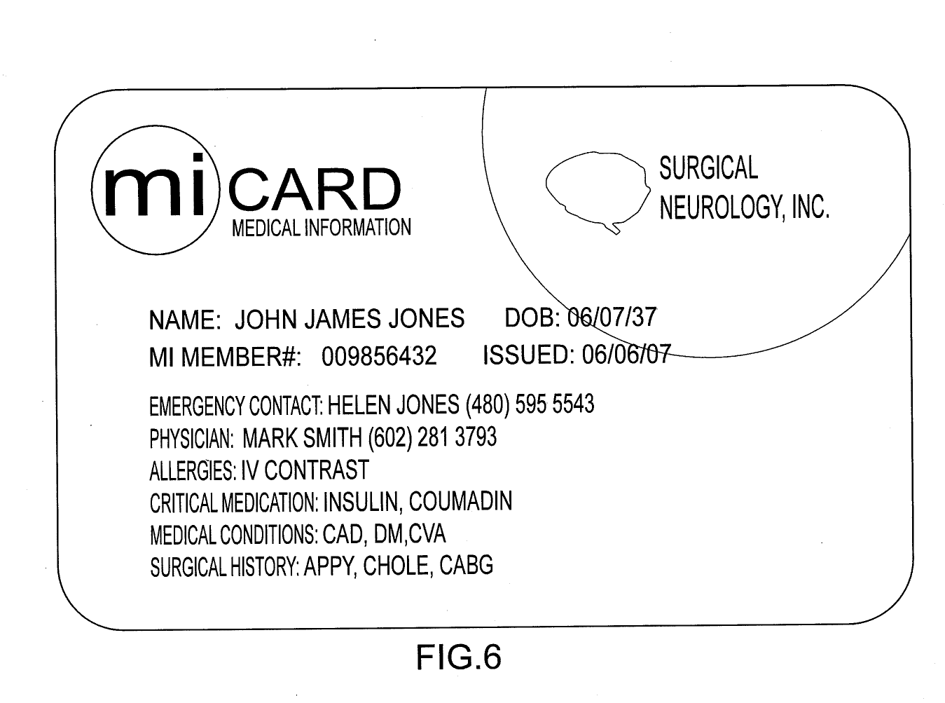

FIG. 6 shows an exemplary presentation of a front side of an individual's physical medical information card which includes the logo of an affiliate or sponsor of the medical information card of the present invention. In this exemplary embodiment, the logo and name of the affiliate/sponsor is placed in the upper right hand corner of the individual's medical information card.

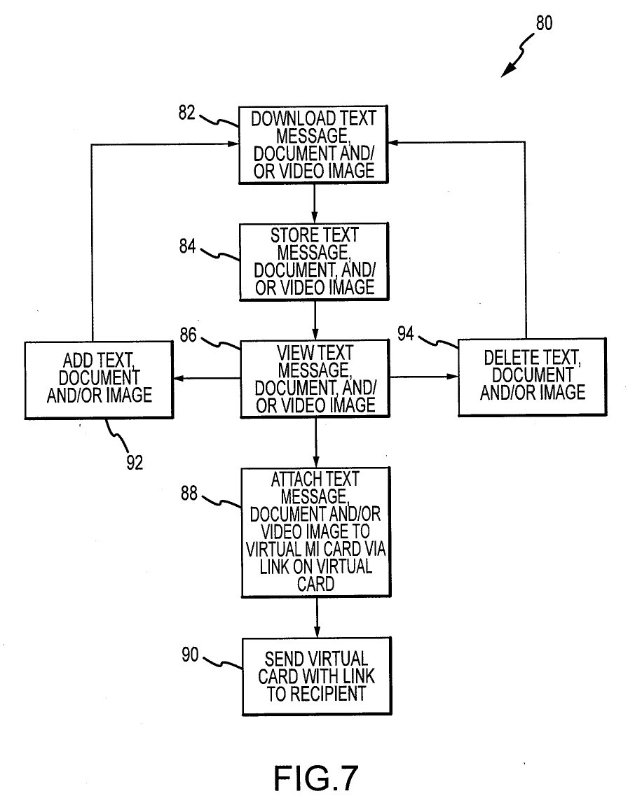

A flowchart 80 showing an exemplary method for managing test messages, documents, and/or video images in association with the method for managing an individual's personal medical information card in accordance with the present invention is shown in FIG. 7. In step 82, an individual can download or upload a test message, a document, and/or a video image clip to the individual's online medical information record. The text message, document, and/or video image clip is then stored in a database relating to the medical information card in step 84. The individual can view the stored text message, document, and/or video image clip in step 86 and the stored text message, document, and/or video image clip is then attached to the individual's online medical information record and/or virtual medical information card via a link contained on the individual's online medical information record and/or virtual medical information card in step 88. Finally, in step 90, the individual can send the individual's virtual medical information card containing the link to a recipient so that the recipient can access the stored text message, document, and/or video image clip. The individual can also add text messages, documents, and/or video image clips in step 92 or delete text messages, documents, and/or video image clips in step 94.

The present invention also contemplates the inclusion of a customized sleeve for an individual's physical medical information card that can be printed into several different languages which identify the card as a medical information card. The present invention also includes medical information band that is a water resistant, highly durable, wristband that contains an emergency contact number and unique medical identification card member number. The medical information card member number can be entered into the emergency provider contact field on the website associated with the medical information card so that treating medical providers can gain instant, on-line, access to a read-only version of the individual's online medical information record and/or virtual medical information card.

The present invention has been described above with reference to exemplary embodiments. However, those skilled in the art, having read this disclosure, will recognize that changes and modifications may be made to the exemplary embodiments without departing from the scope of the present invention. These and other changes or modifications are intended to be included within the scope of the present invention, as expressed in the following claims.

1. A method for managing an individual's personal medical information comprising:
providing internet access to a program for entering and storing an individual's personal medical information;
creating an online medical information record which contains the individual's stored personal medical information;
providing the individual with a physical credit card size medical information card which includes the individual's key medical information from the individual's online medical information record that would be most needed in times of medical emergency and directions for accessing the individual's online medical record;
enabling the individual to update his or her online medical information record with the individual's most recent medical information; and
enabling the individual and others to view a read only version of the individual's online medical information record.

2. The method of claim 1 further comprising the steps of providing an online replica of the individual's most recently updated physical credit card size medical information card and enabling the individual to print the online replica of the individual's most recently updated physical credit card size medical information card.

3. The method of claim 1 wherein the step of providing internet access to a program for entering and storing an individual's personal medical information comprises the step of providing internet access to view, add, delete, change, and send the individual's medical information contained on the virtual medical information card.

4. The method of claim 1 wherein the step of providing internet access to a program for entering and storing an individual's personal medical information comprises the step of providing an individual access number for the individual to enter and store their personal medical information.

5. The method of claim 1 wherein the step of creating an online medical information record comprises the step of creating an online medical information record which contains the individual's stored personal medical information and an affiliation with or connection to at least one of a business and charitable organization through the use of a defined space within the online medical information record which prominently displays graphic and/or textual information related to the business and/or charitable entity including at least one of a logo, symbol, text, and image.

6. The method of claim 5 further comprising the step of enabling the individual to obtain additional information about the affiliated organization by enabling the individual to access a website of the affiliated organization through the program for entering and storing an individual's personal medical information.

7. The method of claim 1 wherein the step of providing internet access to a program for entering and storing an individual's personal medical information comprises the step of entering a name of the individual, a birth date of the individual, and at least one of a blood type of the individual, a list of allergies of the individual, a physician name and number for the individual, a list of medications for the individual, a previous and/or existing medical condition of the individual, a surgical history of the individual, a name and number of a medical power of attorney for the individual, and identification of a medical device implanted within or attached to the individual.

8. The method of claim 7 wherein the step of providing internet access to a program for entering and storing an individual's personal medical information further comprises the step of downloading at least one of an X-ray of the individual, an EKG print out for the individual, and a digitally scanned image relating to the individual.

9. The method of claim 1 wherein the step of providing internet access to a program for entering and storing an individual's personal medical information comprises the step of enabling online access to download, delete, view, and send at least one stored document or image which relates to the individual's personal medical information.

10. The method of claim 9 wherein the step of enabling online access to download, delete, view, and send at least one stored document or image which relates to the individual's personal medical information comprises the step of downloading, deleting, viewing, or sending a personal medical history of the individual, a family medical history of the individual, a medication list of the individual, a living will of the individual, a healthcare power of attorney document for the individual, a lab test result for the individual, and a medical test result image for the individual.

11. The method of claim 9 wherein the step of enabling online access to download, delete, view, and send at least one stored document or image comprises the step of downloading, deleting, viewing, or sending at least one of a text message, an audio message, and a video message.

12. The method of claim 11 wherein the step of downloading, deleting, viewing, or sending at least one of a text message, an audio message, and a video message comprises the step of downloading, deleting, viewing, or sending information left by at least one of an individual whose medical information is contained on the physical credit card size medical information card and a medical care provider for the individual whose medical information is contained on the physical credit card size medical information card.

13. The method of claim 12 wherein the step of downloading, deleting, viewing, or sending information left by at least one of an individual whose medical information is contained on the physical credit card size medical information card and a medical care provider for the individual whose medical information is contained on the physical credit card size medical information card comprises the step of downloading, deleting, viewing, or sending information intended to be shared from one medical provider to another medical provider, information communicated from the individual to a family member or friend of the individual, or information communicated from the individual to a medical provider.

14. The method of claim 1 further comprising the step of incorporating the individual's stored medical information into at least one of a piece of jewelry, an attachment for a piece of jewelry, an article of clothing, and an attachment for an article of clothing.

15. The method of claim 1 further comprising the step of translating information included on an individual's physical credit card size medical information card into another language before the step of printing the physical credit card size medical information card.

16. A personal medical information card system comprising:
an online medical information record containing an individual's personal medical information wherein the online medical information record is capable of being updated on-line by the individual; and
a physical credit card size medical information card which includes the individual's key medical information from the individual's online medical information record that would be most needed in times of medical emergency and directions for accessing the individual's online medical information record.

17. The personal medical information card system of claim 16 wherein the individual's personal medical information includes at least one of a blood type of the individual, a list of allergies of the individual, a physician name and number for the individual, a list of medications for the individual, a previous and/or existing medical condition of the individual, a surgical history of the individual, a name and number of a medical power of attorney for the individual, identification of a medical device implanted within or attached to the individual, an X-ray of the individual, an EKG print of the individual, and a digitally scanned image of the individual.

18. The personal medical information card system of claim 16 wherein the individual's personal medical information included in the individual's online medical information record can be viewed, deleted, added to, changed, or sent via the internet.

19. The personal medical information card system of claim 16 further comprising at least one of a stored document or stored image relating to the individual's online medical information record which can be viewed, deleted, or sent via the internet.

20. The personal medical information card system of claim 19 wherein said at least one of a stored document or stored image comprises a personal medical history, a family medical history, a medication list, a living will, a healthcare power of attorney, a lab test result, and a medical test result image.

21. The personal medical information card system of claim 19 wherein said at least one of a stored document or stored image comprises at least one of a text message, an audio message, and a video message.

22. The personal medical information card system of claim 21 wherein said at least one of a text message, an audio message and a video message includes information left by at least one of an individual whose medical information is contained on the physical credit card size medical information card and a medical care provider for the individual.

23. The personal medical information card system of claim 22 wherein said at least one of a text message, an audio message, and a video message includes one or more of information intended to be shared from one medical provider to another medical provider, information communicated from the individual to a family member or friend, and information communicated from the individual to a medical provider.

24. The personal medical information card system of claim 16 wherein information included on the physical credit card size medical information card is also incorporated into at least one of a piece of jewelry, an attachment for a piece of jewelry, an article of clothing, and an attachment for an article of clothing.

25. The personal medical information card system of claim 16 wherein at least one of the online medical information record and physical credit card size medical information card includes an affiliation with or connection to at least one of a business and charitable organization through the use of a defined space within the online medical information record and/or physical credit card size medical information card which prominently displays graphic and/or textual information related to the business and/ or charitable entity including at least one of a logo, symbol, text, and image.

26. The personal medical information card system of claim 16 wherein information included on the physical credit card size medical information card is capable of being translated on-line into another language.
